(19) United States
(12) Patent Application Publication
(10) Pub. No.: US 2012/0164605 A1
(43) Pub. Date: Jun. 28, 2012

(54) INTERACTIVE LEARNING SYSTEM AND METHOD THEREOF

(75) Inventor: Chien-Chun Sung, Taipei City (TW)

(73) Assignee: ALTEK CORPORATION, Hsinchu City (TW)

(21) Appl. No.: 13/029,132

(22) Filed: Feb. 17, 2011

(30) Foreign Application Priority Data
Dec. 22, 2010 (TW) 99145276

(51) Int. Cl. G09B 19/00

(52) U.S. Cl. 434/81

(57) ABSTRACT

An interactive learning system and method is provided. The interactive system includes a camera device and an interactive device. The camera device executes a functional operation, and transforms the functional operation into executive information. Then, the camera device transmits the executive information to the interactive device. The interactive device generates guiding information for guiding a user to operate the camera device according to model information of the camera device, and transmits the guiding information to the camera device so as to control the camera device to execute a guiding operation related to the guiding information.

### CROSS-REFERENCE TO RELATED APPLICATION

This application claims the priority benefit of Taiwan application serial no. 99145276, filed on Dec. 22, 2010. The entirety of the above-mentioned patent application is hereby incorporated by reference herein and made a part of this specification.

### BACKGROUND

1. Field of the Invention

The invention relates to an interactive learning system and a method thereof. Particularly, the invention relates to an interactive learning system and a method thereof suitable for a camera device.

2. Description of Related Art

Product manuals in the current market are generally attached to the sold products in a paper-type. Due to a complex narration of the manual, a user probably has no patient to read the manual in detail, so that detailed functions of the product are not known by the user, which may even lead to a wrong operation of the product.

Regarding a manual of an electronic device, the related functional descriptions in the manual are relatively complex, so that the user is not easy to learn operation information from the manual. Especially, regarding today's popular cameras, most of the users only know several basic functional operations of the camera, for example, a simple photo-shooting function or a zooming in/out function. However, advanced functions of the camera are hard to be operated according to general knowledge of the camera, for example, adjustments of resolution, sensitivity, contrast and white balance, etc. These adjustments have to be learned by reading the manual.

With widespread of the camera, an age range of the users using the cameras is expanded, while old people may have a problem in reading dense characters of the conventional manual, and children may think the narration of the manual is too esoteric or boring, and therefore the manual cannot draw attention of the users of these age levels. Therefore, the manual loses its teaching function to these users.

Moreover, in the conventional paper-type manual, all of operation steps of the product are introduced, which may consume a large amount of paper, though the user probably only wants to learn functions of interest other than learning all of the operation steps of the product, which may lead to a possibility of waste of paper. Therefore, in today's society emphasising on environmental protection, if a replacement mechanism can be found, it will be helpful to environmental protection.

### SUMMARY OF THE INVENTION

The invention provides an interactive learning system including a camera device and an interactive device. The camera device executes a functional operation, and transforms the functional operation into executive information. The interactive device is connected to the camera device, and generates guiding information for guiding a user to operate a function of the camera device according to model information of the camera device, and transmits the guiding information to the camera device so as to control the camera device to execute a guiding operation corresponding to the guiding information.

In an embodiment of the invention, the interactive device includes a database module, a display module and a control module. The database module provides a functional database and a corresponding learning menu, and the display module displays the learning menu. The control module is connected to the database module for capturing the model information of the camera device, obtaining the functional database and the corresponding learning menu according to the model information, generating the guiding information according to the functional database based on a selection result of the learning menu, and transmitting the guiding information to the camera device so as to control the camera device to execute the guiding operation corresponding to the guiding information.

In an embodiment of the invention, the display module is connected to the control module for displaying a guiding frame corresponding to the guiding information.

In an embodiment of the invention, the control module receives the executive information transformed by the camera device, so as to synchronously display the functional operation currently executed by the camera device in the guiding frame displayed by the display module.

In an embodiment of the invention, the interactive device further includes a feedback module. The feedback module is connected to the control module and used for comparing the executive information and the guiding information to generate feedback information, so as to re-guide the user to operate the function of the camera device.

In an embodiment of the invention, the camera device further executes the functional operation to obtain an image, and the interactive device further receives the image and synchronously displays the image in the guiding frame displayed by the display module.

In an embodiment of the invention, the interactive device is connected to the camera device through a cable entity transmission or a wireless communication transmission.

The invention provides an interactive learning method, adapted to an interactive learning system. The interactive learning method includes following steps. A functional operation of a camera device is transformed into executive information. Guiding information for guiding a user to operate a function of the camera device is generated according to model information of the camera device and transmitted to the camera device so as to control the camera device to execute a guiding operation corresponding to the guiding information.

In an embodiment of the invention, the interactive learning method further includes following steps. The model information of the camera device is captured, and a functional database and a corresponding learning menu are obtained. The guiding information is generated according to the functional database based on a selection result of the learning menu. A guiding frame displays the guiding information. The guiding information is transmitted to the camera device so as to control the camera device to execute the guiding operation corresponding to the guiding information. The guiding frame synchronously displays the functional operation currently executed by the camera device. The executive information and the guiding information are compared to generate feedback information, so as to re-guide the user to operate the function of the camera device.

In an embodiment of the invention, the interactive learning method further includes receiving an image obtained when the camera device executes the functional operation, and synchronously displaying the image in the guiding frame.

According to the above descriptions, the invention provides an interactive learning system and a method thereof, by which based on information communication between the interactive device and the camera device, a user can learn to use the camera device according to an interactive method, and the guiding information ensure the user clearly understanding a using method of the camera device, and the guiding frame opportunely presents a current functional operation of the user. In this way, the user can be always aware of whether or not properly using the camera device. Based on the learning menu, the user can also selectively learn the functions of interest, which is convenient in utilization.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system structural diagram of an interactive learning system according to an exemplary embodiment of the invention.

FIG. 2 is a flowchart illustrating an interactive learning method according to an exemplary embodiment of the invention.

FIG. 3A is a schematic diagram illustrating an implementation of an interactive learning system according to an exemplary embodiment of the invention.

FIG. 3B is a schematic diagram illustrating an implementation of an interactive learning system according to an exemplary embodiment of the invention.

FIG. 4 is a diagram illustrating a learning menu of an interactive learning system according to an exemplary embodiment of the invention.

FIG. 5 is a schematic diagram illustrating basic operations of an interactive learning system according to an exemplary embodiment of the invention.

FIG. 6 is a schematic diagram illustrating advanced operations of an interactive learning system according to an exemplary embodiment of the invention.

### DETAILED DESCRIPTION OF DISCLOSED EMBODIMENTS

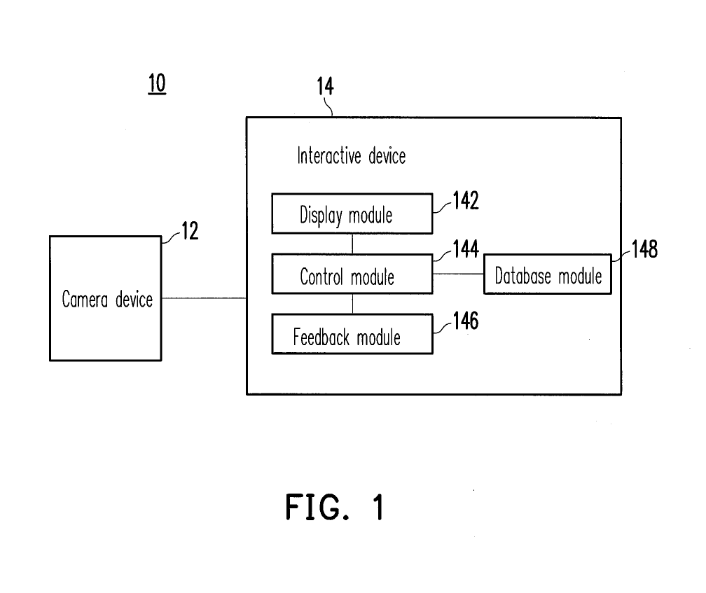

FIG. 1 is a system structural diagram of an interactive learning system according to an exemplary embodiment of the invention. The interactive learning system 10 includes a camera device 12 and an interactive device 14. The interactive device 14 includes a display module 142, a control module 144, a feedback module 146 and a database module 148. The camera device 12 can be a digital camera, or an electronic device having a photo-capturing function such as a mobile phone or a personal digital assistant (PAD), etc. The database module 148 of the interactive device 14 can be a storage device such as an optical disc or a hard disc, etc, or a remote server database connected through a network.

Referring to FIG. 1, the interactive device 14 is connected to the camera device 12 through a cable entity transmission, for example, universal serial bus (USB) or Ethernet, or through a wireless communication transmission, for example, bluetooth or wireless fidelity (WiFi). When the camera device 12 is activated, the camera device 12 initializes the connection with the interactive device 14, and the interactive device 14 obtains model information of the camera device 12 through such connection.

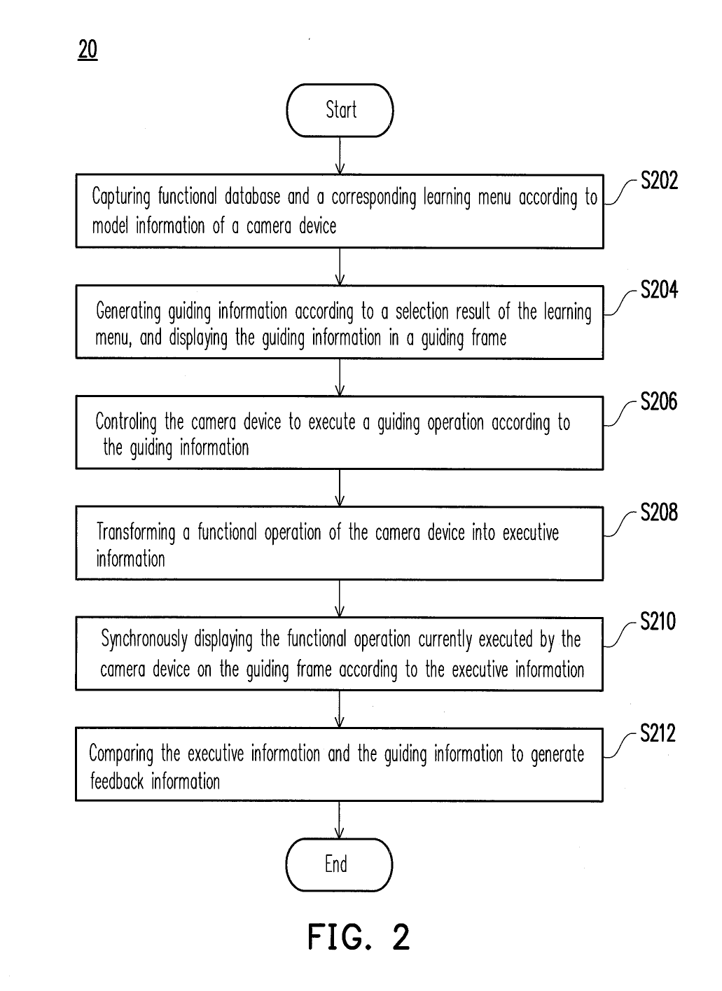

FIG. 2 is a flowchart illustrating an interactive learning method according to an exemplary embodiment of the invention. Referring to FIG. 1 and FIG. 2, in step S202, after the connection between the camera device 12 and the interactive device 14 is initialized, the camera device 12 and the interactive device 14 can communicate with each other, and now the control module 144 of the interactive device 14 captures the model information of the camera device 12. The database module 148 is connected to the control module 144, and provides a functional database and a corresponding learning menu of the camera device 12. When the control module 144 captures the model information of the camera device 12, the control module 144 obtains the functional database and the learning menu from the database module 148 according to the model information of the camera device 12, and displays the learning menu on the display module 142 to facilitate a selection operation of the user.

In step S204, the user selects a function to be learned through the learning menu captured from the database module 148 by the control module 144. After the user performs the selection, the control module 144 generates guiding information according to the functional database based on the selection result of the learning menu. In step S206, the control module 144 transmits the guiding information to the camera device 12 so as to control the camera device 12 to execute a guiding operation corresponding to the guiding information, where the guiding operation may, for example, guide the user through a key lamp indication or a displayed frame indication, which is not limited by the invention. It should be noticed that in an embodiment, after the control module 144 generates the guiding information, the display module 142 can be used to display a guiding frame corresponding to the guiding information, so as to guide the user to perform a functional operation on the camera device 12.

In step S208, the user performs the functional operation on the camera device 12 according to the guiding operation of the camera device 12, and after the camera device 12 executes the functional operation, the camera device 12 transforms the functional operation into executive information, and transmits the executive information to the interactive device 14. In step S210, the control module 144 of the interactive device 14 receives the executive information, and synchronously displays the functional operation currently executed by the camera device 12 in the guiding frame displayed by the display module 142 according to the executive information.

In detail, the functional operation executed on the camera device 12 can also be displayed on the display module 142 in a form of a figure through the interactive device 14, so as to facilitate the user to learn an actual pattern of the executed functional operation. For example, the camera device 12 executes the functional operation to obtain an image, and the interactive device 142 receives the image and synchronously displays the image in the guiding frame of the display module 142.

In step S212, the feedback module 146 compares the executive information received by the control module 144 with the guiding information to generate feedback information, so as to re-guide the user to operate the camera device 12. In detail, if the functional operation executed by the user is not complied with the guiding operation corresponding to the guiding information, for example, a wrong button is pressed to open a wrong menu, the feedback module 146 generates the feedback information to re-guide the user to operate the camera device 12, so as to execute the functional operation indicated by the guiding information.

To make the invention easy to understand, operations of physical devices are introduced below.

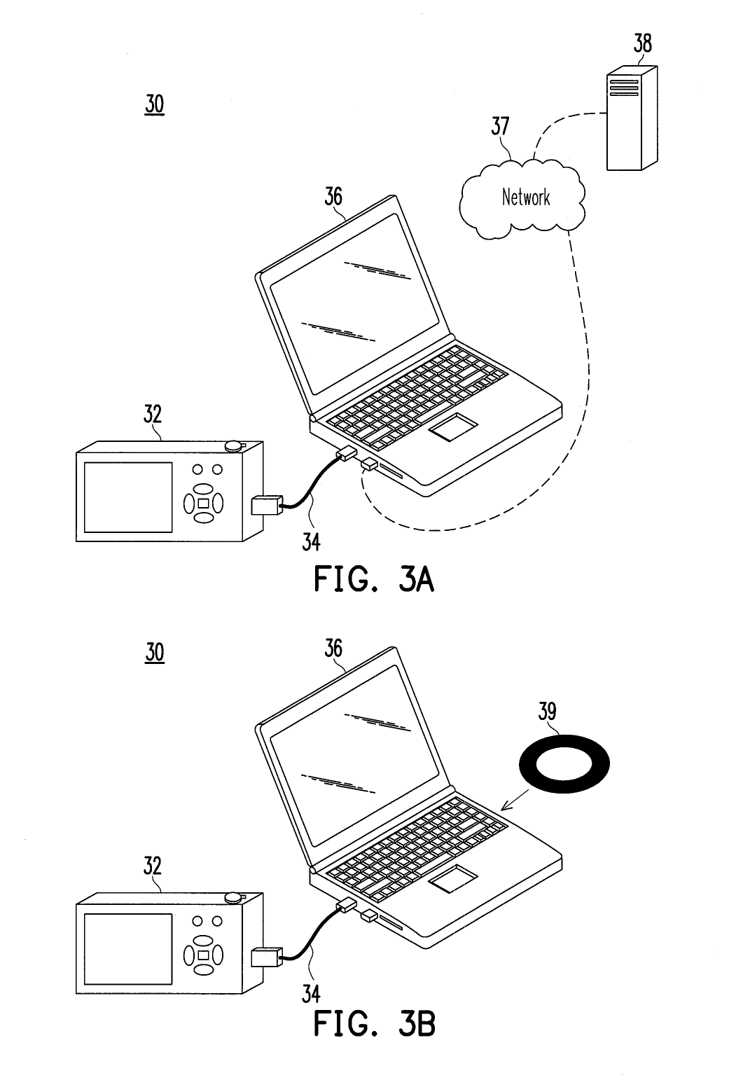

FIG. 3A is a schematic diagram illustrating an implementation of an interactive learning system 30 according to an exemplary embodiment of the invention. The interactive learning system 30 includes a camera 32, a USB connection module 34, a notebook computer 36, a network module 37 and a remote server database 38. In the present exemplary embodiment, the camera 32 and the notebook computer 36 are connected through the USB connection module 34, and when the connection therebetween is enabled, the camera 32 sends an interrupt signal attached with a command code for connecting the Internet to the notebook computer 36. Now, the notebook computer 36 immediately connects a product teaching website of the camera 32 through the network module 37, and obtains data stored in the remote server database 38, where the network module 37 can be a cable network or a wireless network. Then, the notebook computer 36 obtains a functional database and a learning menu supporting an Internet interface from the remote server database 38 according to model information of the camera 32, and the learning menu is displayed on a screen of the notebook computer 36, so that the user can select to learn a desired function according to his own needs.

FIG. 3B is a schematic diagram illustrating an implementation of an interactive learning system 30 according to an exemplary embodiment of the invention. An operation method of the system of FIG. 3B is approximately the same to that of the system of FIG. 3A. After the camera 32 and the notebook computer 36 are connected through the USB connection module 34, and the connection is enabled, the camera 32 sends an interrupt signal attached with a command code for connecting the Internet to the notebook computer 36. If the notebook computer 36 cannot connect the Internet, it may prompt the user to insert a teaching disc 39. Now, the notebook computer 36 obtains a functional database and a learning menu from the teaching disc 39 according to the model information of the camera 32, and the learning menu is displayed on the screen of the notebook computer 36, so that the user can select to learn a desired function according to his own needs.

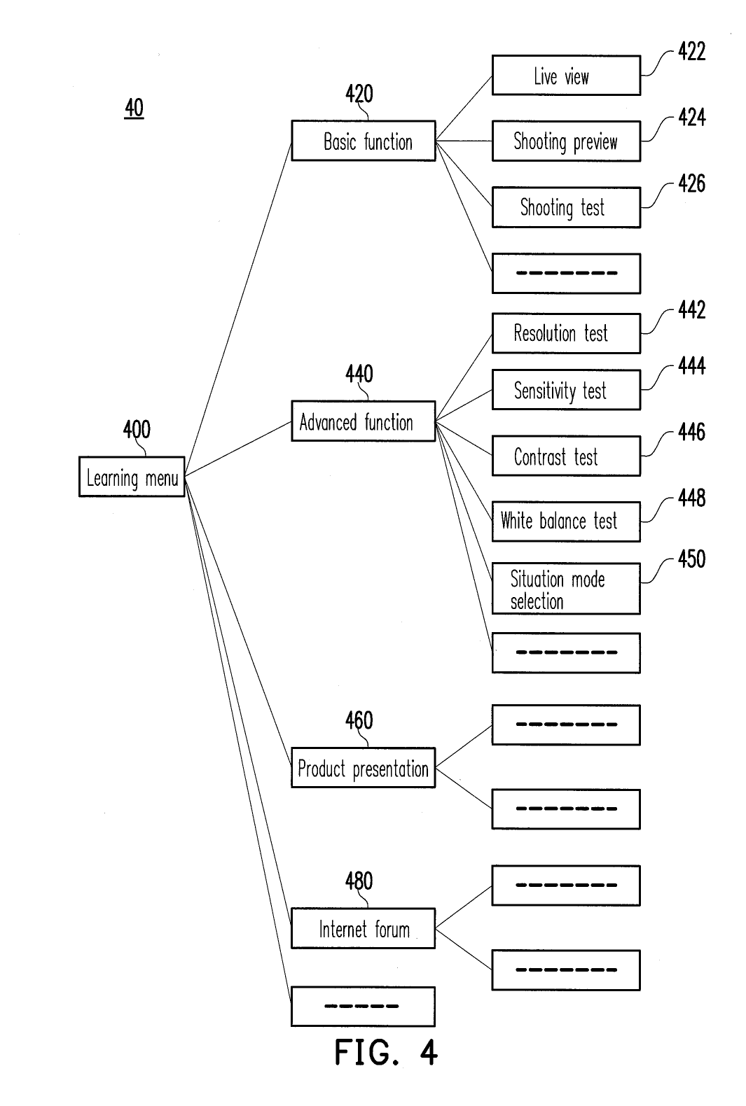

FIG. 4 is a diagram illustrating a learning menu of an interactive learning system according to an exemplary embodiment of the invention. Referring to FIG. 3A and FIG. 4, the learning menu 40 includes a basic function option 420, an advanced function option 440, a product presentation option 460 and an Internet forum option 480, etc. The basic function option 420 includes basic operations of the camera 32 such as a live view option 422, a shooting preview option 424 and a shooting test option 426, etc., which may facilitate the user to learn the basic operations of the camera 32. The advanced function option 440 includes advanced operations of the camera 32 such as a resolution test option 442, a sensitivity test option 444, a contrast test option 446, a white balance test option 448 and a situation mode selection option 450, etc. The product presentation option 460 may present news or latest models related to the brand of the camera 32 for providing new information to the user. The Internet forum option 480 provides a platform where the users may share product using experiences, enjoy digital files, download pictures or join a photo contest. For example, the users may establish picture blogs related to various studies and discussions of the camera and discussions of various pictures, or may constantly conduct photo contest, so that the users may have more enthusiasm in learning and using the camera. Since the Internet forum option 480 requires a function of connecting the Internet, it is adapted to the interactive learning system 30 having the remote server database 38, as shown in FIG. 3A. The function options of the learning menu of FIG. 4 can still be expanded, which is not limited by the invention.

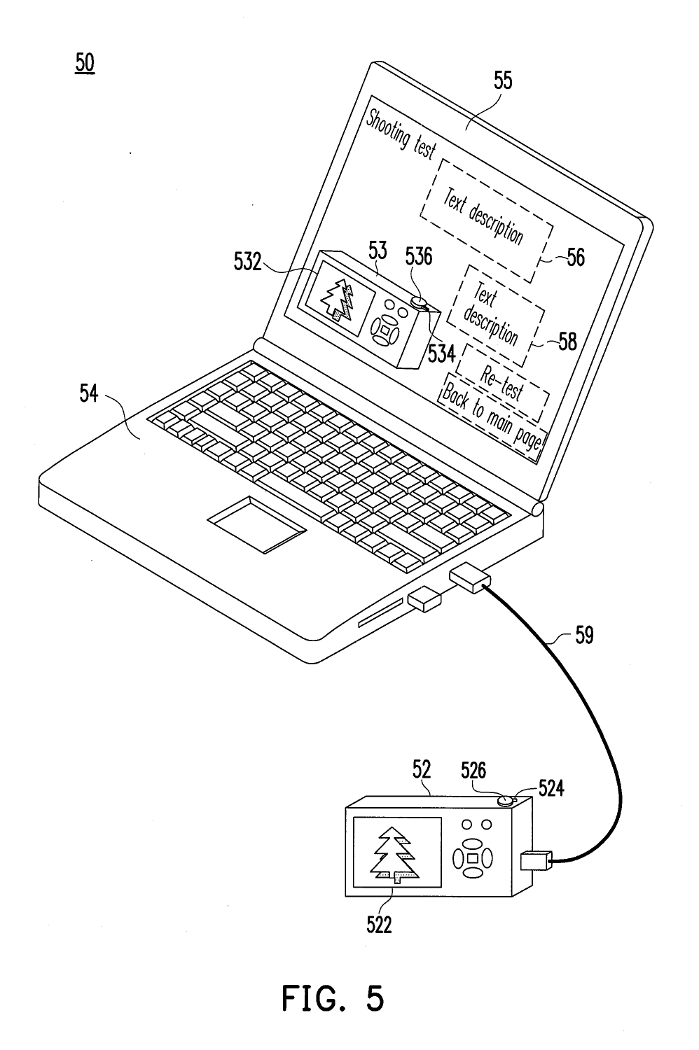

Referring to FIG. 4 and FIG. 5, FIG. 5 is a schematic diagram illustrating basic operations of an interactive learning system 50 according to an exemplary embodiment of the invention. According to a selection result of the learning menu 40 (for example, the user selects the shooting test option 426 in the basic function option 420), a screen 55 of the notebook computer 54 displays a guiding frame including a text description 56, which is a step description of the shooting test option 426. The notebook computer 54 drives a USB module 59 to transmit a specific shooting test command code to the camera 52. After the camera 52 receives the shooting test command code, a liquid crystal screen 522 of the camera 52 is switched to a functional operation frame for executing the shooting test, and now the screen 55 of the notebook computer 54 synchronously displays the functional operation frame that the camera 52 executes the shooting test.

On the guiding frame of the notebook computer 54, a simulated liquid crystal screen 532 of a simulated camera 53 is changed in color for reminding the user to notice the liquid crystal screen 522 of the camera 52. Now, the user can arbitrarily move the camera 52, and an image displayed in the simulated liquid crystal screen 532 of the simulated camera 53 of the notebook computer 54 is consistent to an image in the liquid crystal screen 522 of the camera 52. The text description 56 then reminds the user to zoom in/out a lens of the camera 52. A simulated knob 534 on the simulated camera 53 is also changed in color to remind the user to zoom in/out the camera 52 through a knob 524 on the camera 52. Then, the text description 56 guides the user to press a shutter. A simulated shutter 536 on the simulated camera 53 is changed in color to remind the user to press a shutter 526 on the camera 52 to implement the shooting test. Now, the user presses the shutter 526, and the operation of pressing the shutter 526 is transformed into a specific executive command code, and the executive command code is transmitted to the notebook computer 54. The notebook computer 54 compares the executive command code and the shooting test command code that the notebook computer 54 transmits to the camera 52 previously, i.e. determines whether the executive information of the camera 52 is complied with the guiding information of the notebook computer 54, and generates the feedback information, and displays a corresponding text description 58 on the screen to notify whether the user's operation is correct. Moreover, an image captured by the camera 52 is immediately sent to the notebook computer 54.

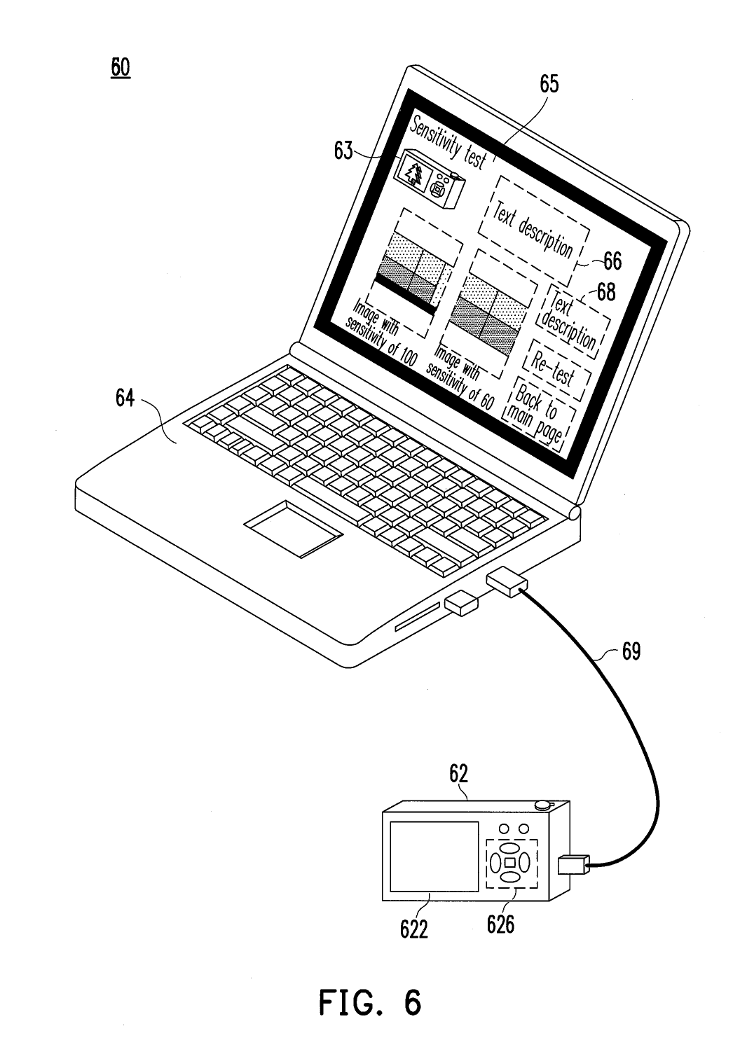

Referring to FIG. 4 and FIG. 6, FIG. 6 is a schematic diagram illustrating advanced operations of an interactive learning system 60 according to an exemplary embodiment of the invention. According to a selection result of the learning menu 40 (for example, the user selects the sensitivity test option 444 in the advanced function option 440), a screen 65 of the notebook computer 54 displays a guiding frame including a text description 66, which is a step description of the sensitivity test option 444. The notebook computer 64 drives a USB module 69 to transmit a specific sensitivity test command code to the camera 62. After the camera 62 receives the sensitivity test command code, a liquid crystal screen 622 of the camera 62 is switched to a functional operation frame for executing the sensitivity test, and now the screen 65 of the notebook computer 64 synchronously displays the functional operation frame that the camera 62 executes the sensitivity test.

The text description 66 and a simulated camera 63 may remind the user to use a functional key 626 of the camera 62 to adjust the sensitivity, and guide the user to capture two images respectively having sensitivities of 100 and 60. The two images are transmitted to the notebook computer 64 through the USB module 69, and a text description 68 describes analysis results of the two images, and guides the user to learn a difference between the two images respectively having sensitivities of 100 and 60. In this way, teaching of the sensitivity test option 444 is completed, and the user may have a better understanding of the function of sensitivity.

In summary, the invention provides an interactive learning system and a method thereof, in which based on the interactive learning method, text and picture descriptions and a dynamic interface, the user can learn to use the camera in a more convenient and fun way. The user can communicate with the interactive learning system and choose to learn a function of interest. Based on a guiding function of the system, the user may have a better understanding of an operation flow of the camera, and based on a feedback function of the system, if the user performs a wrong operation, the system can immediately notify the user for correction. In this way, the conventional paper-type manual can be replaced by such fun, easy and convenient learning system, so that the users of different age levels can use such interactive learning system to learn various functions of the camera. Moreover, in today's society emphasising on environmental protection, paper waste can be reduced by reducing printing of the paper-type manuals, so as to achieve a purpose of environmental protection.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An interactive learning system, comprising:
a camera device, for executing a functional operation, and transforming the functional operation into executive information; and
an interactive device, connected to the camera device, for generating guiding information for guiding a user to operate a function of the camera device according to model information of the camera device, and transmitting the guiding information to the camera device so as to control the camera device to execute a guiding operation corresponding to the guiding information.

2. The interactive learning system as claimed in claim 1, wherein the interactive device comprises:
a database module, for providing a functional database and a corresponding learning menu;
a display module, for displaying the learning menu; and
a control module, connected to the database module, for capturing the model information of the camera device, obtaining the functional database and the corresponding learning menu according to the model information, generating the guiding information according to the functional database based on a selection result of the learning menu, and transmitting the guiding information to the camera device, so as to control the camera device to execute the guiding operation corresponding to the guiding information.

3. The interactive learning system as claimed in claim 2, wherein the display module is connected to the control module for displaying a guiding frame corresponding to the guiding information.

4. The interactive learning system as claimed in claim 3, wherein the control module receives the executive information transformed by the camera device, so as to synchronously display the functional operation currently executed by the camera device in the guiding frame displayed by the display module.

5. The interactive learning system as claimed in claim 4, wherein the interactive device further comprises:
a feedback module, connected to the control module, for comparing the executive information and the guiding information to generate feedback information, so as to re-guide the user to operate the function of the camera device.

6. The interactive learning system as claimed in claim 3, wherein the camera device further executes the functional operation to obtain an image, and the interactive device further receives the image and synchronously displays the image in the guiding frame displayed by the display module.

7. The interactive learning system as claimed in claim 1, wherein the interactive device is connected to the camera device through a cable entity transmission or a wireless communication transmission.

8. An interactive learning method, adapted to an interactive learning system, the method comprising:
transforming a functional operation of a camera device into executive information; and
generating guiding information for guiding a user to operate a function of the camera device according to model information of the camera device, and transmitting the guiding information to the camera device so as to control the camera device to execute a guiding operation corresponding to the guiding information.

9. The interactive learning method as claimed in claim 8, further comprising:
capturing the model information of the camera device, and obtaining a functional database and a corresponding learning menu;
generating the guiding information according to the functional database based on a selection result of the learning menu;
displaying the guiding information;
synchronously displaying the functional operation currently executed by the camera device; and
comparing the executive information and the guiding information to generate feedback information, so as to re-guide the user to operate the function of the camera device.

10. The interactive learning method as claimed in claim 9, further comprising:
receiving an image obtained when the camera device executes the functional operation; and
synchronously displaying the image in the guiding frame.
